(19) United States
(12) Patent Application Publication
(10) Pub. No.: US 2017/0300516 A1
(43) Pub. Date: Oct. 19, 2017

(54) SYSTEM AND METHOD FOR BUILDING A DWARF DATA STRUCTURE

(71) Applicant: Kyvos Insights, Inc., Los Gatos, CA (US)

(72) Inventors: Ankit KHANDELWAL, Indore (IN); Sajal RASTOGI, Ghaziabad (IN); Kapil GHODAWAT, Indore (IN)

(21) Appl. No.: 15/488,856

(22) Filed: Apr. 17, 2017

(30) Foreign Application Priority Data
Apr. 15, 2016 (IN) 201621005260

(51) Int. Cl. G06F 17/30

(52) U.S. Cl. CPC G06F 17/30333; G06F 17/30424; G06F 17/30958

(57) ABSTRACT

Systems and methods for building a dwarf data structure with reduced size and improved query performance is disclosed. The system is configured to perform three major steps for reducing size of Dwarf data structure and improving query performance. In the first step, the system is configured to reducing the Dwarf data structure size by physical compression of the clustered node blocks of the Dwarf data structure when writing the nodes on a disk. In the second step, the system is configured to improve query performance by look-ahead reading, wherein an entire block of nodes is loaded into random access memory, as there is a very high probability of occurrence of the nodes required to be accessed from same block. In the third step, the system is configured to reduce the number of nodes/blocks read while serving range queries thereby improving query performance while retrieving data from Dwarf data structure.

### CROSS-REFERENCE TO RELATED APPLICATIONS AND PRIORITY

The present application claims priority from provisional patent application filed titled “REDUCING SIZE OF DWARF DATA STRUCTURE AND IMPROVING QUERY PERFORMANCE” having Application Number “201621005260” filed on “Apr. 15, 2016”.

### FIELD OF INVENTION

The present disclosure relates to a field of building a dwarf data structure. More particularly, the present disclosure relates to a system and method for utilizing node clustering in the process of building Dwarf data structure.

### BACKGROUND

With advent in technology, organizations are increasingly capturing and storing data generated by machines and humans, thereby resulting in generation of extremely large amount of data. The data generated comprises server logs or records of user interaction, sales data, product information, etc. In order to effectively organize the data, the organizations utilize On-Line Analytical Processing (OLAP) systems. Generally, OLAP systems facilitate and manage transaction based applications. OLAP systems may refer to a variety of transactions such as database management system transactions, business transactions, or commercial transactions.

The OLAP systems enable users to analyze multidimensional data. Generally, analysis on the multidimensional data may include one or more operations such as, aggregate the data, drill-down, slice and dice the data. The slice and dice operation comprises taking specific sets of data and viewing the data from multiple viewpoints. Basis for the OLAP system is an OLAP cube. The OLAP cube is a data structure allowing for fast analysis of the data with capability of manipulating and analyzing the data from multiple perspectives. Typically, the OLAP cubes are composed of numeric facts, called measures, and are categorized by dimensions. The measures are derived from fact tables, wherein the fact tables are typically composed of the measurements or data of a business process, e.g. number of products sold in a retail store. The dimensions are derived from dimension tables. In other words, a measure has a set of labels, where the description of the labels is provided in corresponding dimension.

However, the size of the OLAP cube goes on increasing as the number of dimensions in the OLAP cube increases. To address this problem, Dwarf data structures are used. Dwarf data structures stores aggregations as a Directed Acyclic Graph (DAG) of nodes. A Dwarf data structure is a Directed Acyclic Graph (DAG) of multiple nodes. One of the known strategies for improving the performance of OLAP queries from Dwarf data structure is clustering of nodes. However, even after use of Dwarf data structure, the query time is largely dependent on the time it takes to retrieve data from the storage space.

### SUMMARY

This summary is provided to introduce concepts related to systems and methods for building a dwarf data structure as well as fetching data from the dwarf data structure and the concepts are further described below in the detailed description. This summary is not intended to identify essential features of the claimed subject matter nor is it intended for use in determining or limiting the scope of the claimed subject matter.

In one implementation, a method for fetching data from a dwarf data structure is illustrated. The method comprises three major steps of building the dwarf data structure, querying the dwarf data structure and fetching data from a dwarf data structure. In one embodiment, the method for building the dwarf data structure, configured to maintain a set of nodes, comprises the step of generating the set of nodes corresponding to the dwarf data structure, wherein each node is configured to maintain information of a data point corresponding to one or more dimensions from a set of dimensions associated with a fact table. Further, the method comprises determining a first set of views corresponding to the set of dimensions, wherein each view from the first set of views is associated with a subset of nodes from the set of nodes. Further, the method comprises identifying a second set of views from the first set of views. The second set of views are determined based on a set of predefined parameters. Further, the method comprises generating one or more data block corresponding to each view from the second set of views. In one embodiment, the one or more data blocks corresponding to each view are configured to store the subset of nodes corresponding to the view from the second set of views. Further, the method comprises storing the one or more blocks corresponding to each view from the second set of views in a secondary memory. The one or more blocks corresponding to each view from the second set of views are stored in the form of a linked list. Further, the method comprises maintaining a block-relative position, corresponding to each node stored in the secondary memory, in a lookup file to build the dwarf data structure in the secondary memory. Further, the method comprises receiving a range query for retrieving target data from the dwarf data structure. Further, the method comprises identifying one or more target views corresponding to the target data based on processing of the range query. Further, the method comprises loading the one or more blocks corresponding to the one or more target views, from the dwarf data structure, into a primary memory. The one or more blocks are identified using the lookup file. Further, the method comprises processing the one or more blocks loaded in the primary memory to fetch the target data.

In one embodiment, a system for fetching data from a dwarf data structure is illustrated. The system comprises a memory and a processor configured to process programmed instructions stored in the memory. The system may be configured for performing the steps of building the dwarf data structure, querying the dwarf data structure and fetching data from a dwarf data structure. Initially, the system may generate a set of nodes corresponding to the dwarf data structure. In one embodiment, each node is configured to maintain information of a data point corresponding to one or more dimensions from a set of dimensions associated with a fact table. Further, the system may determine a first set of views corresponding to the set of dimensions, wherein each view from the first set of views is associated with a subset of nodes from the set of nodes. Further, the system may identify a second set of views from the first set of views. The second set of views are determined based on a set of predefined parameters. Further, the system may generate one or more data block corresponding to each view from the second set of views. In one embodiment, the one or more data blocks corresponding to each view are configured to store the subset of nodes corresponding to the view from the second set of views. Further, the system may store the one or more blocks corresponding to each view from the second set of views in a secondary memory. The one or more blocks corresponding to each view from the second set of views are stored in the form of linked list. Further, the system may maintain a block-relative position, corresponding to each node stored in the secondary memory, in a lookup file to build the dwarf data structure in the secondary memory. Further, the system may receive a range query for retrieving target data from the dwarf data structure. Further, the system may identify one or more target views corresponding to the target data based on processing of the range query. Further, the system may load the one or more blocks corresponding to the one or more target views, from the dwarf data structure, into a primary memory. The one or more blocks are identified using the lookup file. Further, the system may process the one or more blocks loaded in the primary memory to fetch the target data.

In yet another embodiment, a computer program product having embodied computer program for fetching data from a dwarf data structure is disclosed. The program may comprise a program code for performing three major steps of building the dwarf data structure, querying the dwarf data structure and fetching data from a dwarf data structure. Further, program may comprise a program code for generating the set of nodes corresponding to the dwarf data structure, wherein each node is configured to maintain information of a data point corresponding to one or more dimensions from a set of dimensions associated with a fact table. Further, program may comprise a program code for determining a first set of views corresponding to the set of dimensions, wherein each view from the first set of views is associated with a subset of nodes from the set of nodes. Further, program may comprise a program code for identifying a second set of views from the first set of views. The second set of views are determined based on a set of predefined parameters. Further, program may comprise a program code for generating one or more data block corresponding to each view from the second set of views. In one embodiment, the one or more data blocks corresponding to each view are configured to store the subset of nodes corresponding to the view from the second set of views. Further, program may comprise a program code for storing the one or more blocks corresponding to each view from the second set of views in a secondary memory. The one or more blocks corresponding to each view from the second set of views are stored in the form of linked list. Further, program may comprise a program code for maintaining a block-relative position, corresponding to each node stored in the secondary memory, in a lookup file to build the dwarf data structure in the secondary memory. Further, program may comprise a program code for receiving a range query for retrieving target data from the dwarf data structure. Further, program may comprise a program code for identifying one or more target views corresponding to the target data based on processing of the range query. Further, program may comprise a program code for loading the one or more blocks corresponding to the one or more target views, from the dwarf data structure, into a primary memory. The one or more blocks are identified using the lookup file. Further, program may comprise a program code for processing the one or more blocks loaded in the primary memory to fetch the target data.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to refer like/similar features and components.

FIG. 1 illustrates a dwarf data structure and nodes corresponding to the dwarf structure.

FIG. 2 illustrates node reading cycle in the conventional Dwarf data structure.

FIG. 3 illustrates network implementation of a system for building a dwarf data structure and fetching data from the dwarf data structure, in accordance with an embodiment of the present disclosure.

FIG. 4 illustrates the system for building a dwarf data structure and fetching data from a dwarf data structure, in accordance with an embodiment of the present disclosure.

FIG. 5 illustrates a method for building a dwarf data structure and fetching data from a dwarf data structure, in accordance with an embodiment of the present disclosure.

FIG. 6 illustrates node reading cycle using the system, in accordance with an embodiment of the present disclosure.

### DETAILED DESCRIPTION

Some embodiments of the present disclosure, illustrating all its features, will now be discussed in detail. The words “generating”, “determining”, “identifying”, “storing”, “maintaining” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Various modifications to the embodiment will be readily apparent to those skilled in the art and the generic principles herein may be applied to other embodiments. However, one of ordinary skill in the art will readily recognize that the present disclosure for fetching data from a dwarf data structure is not intended to be limited to the embodiments illustrated, but is to be accorded the widest scope consistent with the principles and features described herein.

In one implementation, a system for building a Dwarf data structure with improved query performance is disclosed. The system comprises a memory and a processor configured to execute programmed instructions stored in the memory to perform three major steps for building the Dwarf data structure with reduced size and improving query performance. In the first step, the system is configured to reducing the Dwarf data structure size by physical compression of the clustered node blocks of the Dwarf data structure when writing the nodes on a disk. In the second step, the system is configured to improve query performance by look-ahead reading, wherein an entire block of nodes is loaded into random access memory, as there is a very high probability of occurrence of the nodes required to be accessed from same block. In the third step, the system is configured to reduce the number of nodes or blocks read while serving range queries thereby improving query performance while retrieving data from Dwarf data structure.

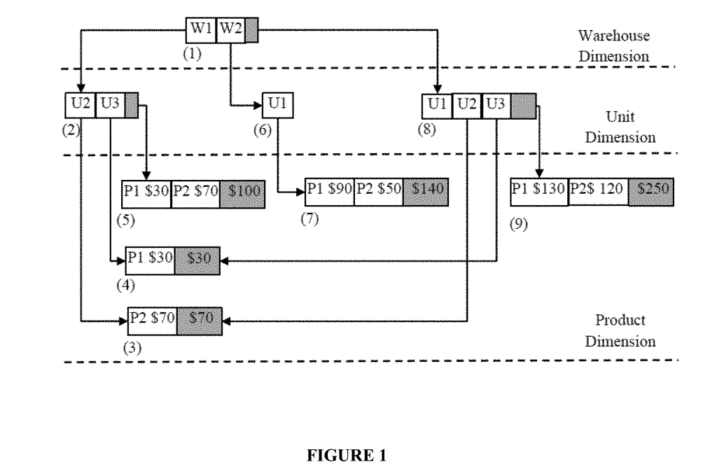

Referring now to FIG. 1, a conventional Dwarf data structure representing three dimensions namely Warehouse, Unit, and Product is illustrated. Due to the clustering of warehouse-unit View, the nodes 2 and 6 are written together. If the number of nodes is more, then the nodes may be stored at multiple blocks of the same view. Similarly, due to clustering of Warehouse-Product-unit View the nodes 3, 4 and 7 are written together.

In one embodiment, while serving a query to get all the combinations of Warehouse-Unit-Product the conventional process needs to scan nodes 1,2,3,4,6, and 7. However, using the present claimed system, to serve this query, 6 different random reads for these 6 nodes is not required. The system is configured to read only 3 blocks (1 block for node 1, 1 block for node 2 and node 6, and 1 block for node 3, node 4, node 7) to get all the combinations of Warehouse-Unit-Product. This reduces the number of random reads performed during the query and improve the response time specially when the reading is done from a distribute File System like HDFS, where a random seek and read more disk I/O.

In the third block, the system is configured to reduce the number of nodes or blocks read while serving range queries thereby improving query performance while retrieving data from Dwarf data structure. Since the above clustering strategy disclosed in second block has been taken into consideration during the Dwarf data structure build process, this strategy may further be utilized to reduce the number of nodes read and improve certain range queries response times. If a query includes a number of dimensions where all the possible values of the root dimension are included, then to serve such a query, the system is configured to take advantage of node clustering.

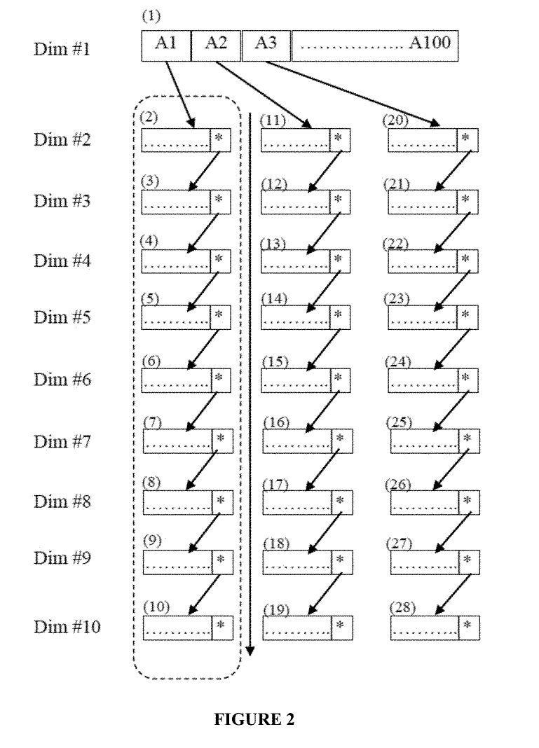

Referring now to FIG. 2, a convention reading cycle of a conventional Dwarf data structure, is illustrated. As represented in FIG. 2, by implementing the conventional system, all the nodes need to be traversed starting from root node and then traversing down the conventional Dwarf data structure in order to server the range query.

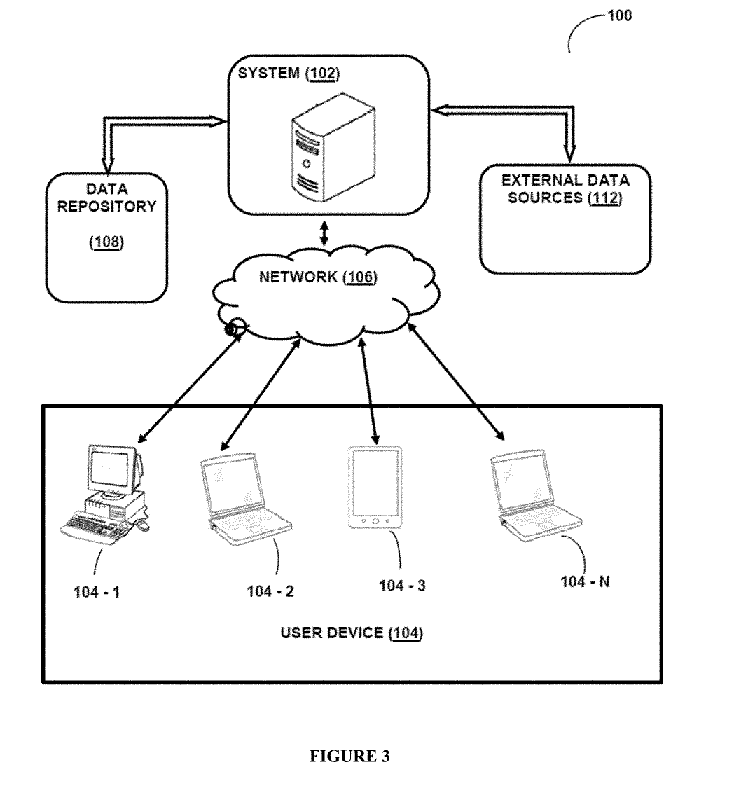

Referring now to FIG. 3, a network implementation 100 of a system 102 for building the dwarf data structure and fetching data from the dwarf data structure is disclosed. Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented in a cloud-based environment. It will be understood that the system 102 may be accessed by multiple users through one or more user devices 104-1, 104-2 . . . 104-N, collectively referred to as user device 104 hereinafter, or applications residing on the user device 104. Examples of the user device 104 may include, but are not limited to, a portable computer, a personal digital assistant, a handheld device, and a workstation. The user device 104 may be communicatively coupled to the system 102 through a network 106. Further, the system 102 is configured to communicate with external data sources 112 and a data repository 108. The external data sources 112 may include data warehouse, set of sensors, POS systems, and a like. Further, one the dwarf data structure is generated, the data repository 108 may be configured to store the dwarf data structure.

In one implementation, the network 106 may be a wireless network, a wired network or a combination thereof. The network 106 may be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

In one implementation, the system 102 may comprise a memory and a processor coupled to the memory. The processor may be configured to execute programmed instructions stored in the memory. In one embodiment, the processor may execute programmed instructions stored in the memory for receiving processed analytical data from the external data sources 112. Once the processed analytical data is received, the processor may be configured to perform three major steps of building the Dwarf data structure with reduced size, querying the dwarf data structure and retrieving data from the Dwarf data structure.

In the first step, the system is configured to cluster nodes of the Dwarf data structure based on “group by” view and reduce the Dwarf data structure size by physical compression of the clustered node blocks of the Dwarf data structure when writing the clustered node blocks on a disk (physical memory). The purpose of clustering is to keep those nodes close to one another which are required to be read together at the time of query processing. In order to achieve faster query processing clusters of nodes as per the “group by” view (i.e. all nodes that belong to same “group by” view) may be kept together in one or more blocks. However, in a Dwarf data structure there may be many possible “group by” views and creating so many clusters of nodes is not practically feasible due to memory needs and/or Dwarf data structure build time impact. If all clusters are maintained simultaneously during the build time, the amount of memory required to store the cube is very large. On the other hand, if multiple iterations are performed to compute views one-by-one then the Dwarf data structure build-time will be higher than the desired time. Hence, the system is configured to cluster nodes for few selected “group by” views and all nodes not belonging to any of the selected group by view are kept in one or more global blocks. In one embodiment, clustering of group by views may be performed using different strategies that are based on based on amount of available memory, views that can give maximum leverage during querying and the like.

Once all the “group by” views that need to be clustered are selected, in the next step, the system is configured to assign a unique view number to each “group by” view and all remaining group by views are assigned a global view number. For example, considering a cube with four dimensions D1, D2, D3, and D4. In this example, the system is configured to generate the group by views as shown in table 1.

TABLE 1
Group by views with four dimensions D1, D2, D3, and D4.

| | |
|---|---|
| Group By View | View Number |

Cuboids with root dimension ‘D1’

| | |
|---|---|
| D1, D2 | 0 |
| D1, D3 | 1 |
| D1, D4 | 2 |
| D1, D2, D3 | 3 |
| D1, D2, D4 | 4 |
| Global | 5 |

As represented in table 1, at the time of building the cube, the system is configured to maintain six blocks (one block for each view and one global block for all non-clustered nodes) where size of each block is fixed, (i.e. 1 MB). In one embodiment, the system may be configured to generate a one or more global blocks configured to store all the nodes, from the first set of nodes, corresponding to one or more global views. The system is configured to assign a sequence number to each block hereafter referred to as the block number. There may be multiple 1 MB blocks for a view depending on how many nodes belong to that view.

During building of a Dwarf data structure, whenever a node needs to be closed, the system is configured to write it to the block to which the node belongs by its “group by” view (i.e. Due to suffix coalescing, a node may belong to multiple group by views, in this case the system chooses to keep the node with smallest length group by view).

In Dwarf data structure, file position for the closed node is maintained by the cell(s) of the upper level nodes. In one embodiment, instead of maintaining the absolute file position where the node is written, the system is configured to maintain block number in which node is written and the offset within the block in a lookup file. Both the block number and offset within the block is maintained using a single long number, referred as block-relative position, by the system, in the lookup file. In one embodiment, the system is configured to reserve 20 bits to keep the offset within the block assuming 1 MB block size and remaining 44 bits to represent block number as shown in table 2.

TABLE 2
A Cell Pointer

| Block Number | Offset |
|---|---|
| 44 bits | 20 bits |

The number of bits assigned to the offset may be increased if the size of the block is more than 1 MB. Keeping block-relative positions for closed nodes enables flexibility to write the block to any place in the actual physical file and the system may only need to maintain a mapping of block number to its position in the physical file.

At the second phase, whenever the system 102 needs to read the node, the system is configured to read the entire block of node, decompress the block and then read the node using the offset. In one embodiment, physical compression is performed by the system 102. Using the block-relative positions for closed nodes gives the system 102 flexibility to write the block to any place in the actual physical file (Secondary memory), wherein the system is configured to maintain a mapping of block number to its position in the physical file for retrieval of data. This also allows the user a flexibility to apply physical compression on the block before writing the blocks on disk. As size of block is relatively large as compared to a node, applying physical compression (like lz4) gives a good amount of reduction in its size (30-50% reduction in the size of the cube). Further, the system 102 is configured to apply delta packing for the cell IDs and node positions in the nodes, which makes it more suitable for compression as after delta packing most of the cell IDs and disk position becomes similar.

In one embodiment, in the second block where query is executed, the system 102 is configured to improve query performance by look-ahead reading, wherein an entire block of nodes is loaded into random access memory, as there is a very high probability of occurrence of the nodes required to be accessed from same block.

In one embodiment, when users query a cube, they are usually interested in few specific dimensions of the cube and it is very probable that the queries that get generated belong to few specific group by views. While querying a Dwarf data structure (i.e. to serve user queries) nodes belonging to different blocks in different clusters need to read. While reading a node, the system 102 is configured to read the entire block of a node into the random access memory. Due to clustering, there is a high probability of finding the next nodes in same set of blocks that is held in random access memory.

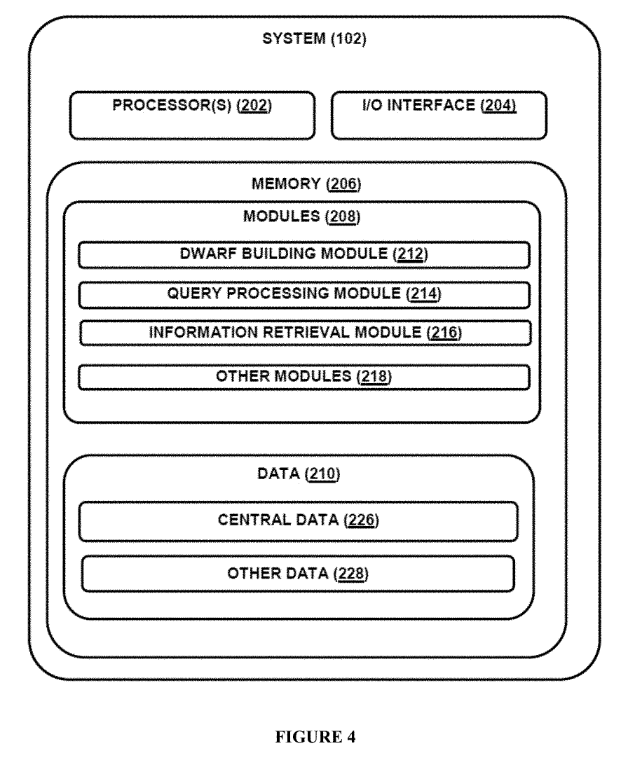

In one embodiment, the system 102 enables reducing the number of disk I/O operation requests made to read a node. Though the benefit is independent of the File System used beneath but in case of a distributed File System like HDFS the system 102 improves the performance of the queries drastically. The system 102 for generating the dwarf data structure and fetching data from the dwarf data structure is further elaborated with respect to the FIG. 4.

Referring now to FIG. 4, the system 102 for generating the dwarf data structure and fetching data from the dwarf data structure is illustrated in accordance with an embodiment of the present subject matter. In one embodiment, the system 102 may be configured to communicate with the external data sources 112 and the data repository 108. The system may comprise at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, at least one processor 202 may be configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the user device 104. Further, the I/O interface 204 may enable the system 102 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 may include routines, programs, objects, components, data structures, and the like, which perform particular tasks, functions or implement particular abstract data types. In one implementation, the module 208 may include a dwarf building module 212, a query processing module 214, an information retrieval module 216, and other modules 218. The other modules 218 may include programs or coded instructions that supplement applications and functions of the system 102.

The data 210, amongst other things, serve as a repository for storing data processed, received, and generated by one or more of the modules 208. The data 210 may also include a central data 226, and other data 228. In one embodiment, the other data 228 may include data generated as a result of the execution of one or more modules in the other module 218.

In one implementation, a user may access the system 102 via the I/O interface 204. The user may be registered using the I/O interface 204 in order to use the system 102. In one aspect, the user may access the I/O interface 204 of the system 102 for obtaining information, providing input information or configuring the system 102.

In one embodiment, the dwarf building module 212 may generate a dwarf data structure configured to maintain a set of nodes. In one embodiment, for the purpose of building the dwarf data structure, the dwarf building module 212 may first receive processed analytical data from external data sources 112. Further, the dwarf building module 212 may be configured to generate a fact table based on the processed analytical data. Furthermore, the dwarf building module 212 may generate a set of nodes corresponding to the dwarf data structure. In one embodiment, each node from the set of nodes is configured to maintain information of a data point corresponding to one or more dimensions from a set of dimensions associated with the fact table. In one embodiment, one or more techniques available in the art may be used for generating the set of nodes.

Once the set of nodes is generated, the dwarf building module 212 may determine a first set of views corresponding to the set of dimensions. The first set of views comprises all the views that may be generated using the possible combination of dimensions from the set of dimensions. In one embodiment, each view from the first set of views is associated with a subset of nodes from the set of nodes. Further, the dwarf building module 212 may identify a second set of views from the first set of views based on a set of predefined parameters. The set of predefined parameters may include available memory space in the data repository 108, views that may give maximum leverage during querying, and the like.

Further, the dwarf building module 212 may generate one or more data block corresponding to each view from the second set of views. The one or more data blocks corresponding to each view are configured to store a subset of nodes corresponding to the view from the second set of views. In one embodiment, a node from the first set of nodes may be common to two or more views, from the second set of views. In such a situation, the dwarf building module 212 a view, from the two or more views, having least number of dimensions associated therewith is identified. One the view with least number of dimensions is identified, the dwarf building module 212 is configured to store the node in a block corresponding to the view with the least number of dimensions.

The size of the data block may be determined based on the number of dimensions associated with the dwarf data structure and the density of the dwarf data structure. Further, the dwarf building module 212 may store the one or more blocks corresponding to each view from the second set of views in a secondary memory/data repository 108. It is to be noted that all the data blocks corresponding to a particular view from the second set of views are stored in the form of linked list. By storing the data blocks in the form of a linked list, the system 102 may easily retrieve the data blocks that belong to the same view using the pointers of the linked list, wherein a pointer, corresponding to a block, points to the memory location of the succeeding block. The dwarf building module 212 may further generate one or more global blocks. The one or more global blocks may be configured to store all the nodes, from the first set of nodes, corresponding to one or more global views that are not a part of the second set of views. The one or more global blocks enables maintaining all the nodes that are less frequently used. Further, the dwarf building module 212 may pre-process the one or more blocks corresponding to the second set of views and the one or more global blocks before loading the one or more blocks corresponding to the second set of views and the one or more global blocks in the secondary memory. The preprocessing may correspond to physical compression of the blocks to be stored in the secondary memory (Disk space).

Further, the dwarf building module 212 may maintain a block-relative position, corresponding to each node stored in the secondary memory, in a lookup file. The block-relative position may be a combination of a block number corresponding to the block and an offset value indicating position of the node in the block. The combination of block number and offset value for each node may be used to identify the physical location of each node in data repository 108.

In one embodiment, once the dwarf data structure is generated and stored in the data repository 108, the query processing module 214 is configured to receiving a range query for retrieving target data from the dwarf data structure. The range query may be received from a user device 104 linked with the system 102.

Further, query processing module 214 is configured to identify one or more target views corresponding to the target data based on processing of the range query. For example, the range query may correspond to target data stored in a data blocks associated with a particular view from the second set of views. This view is referred to as the target view, and data blocks corresponding to the target view are identified from the secondary memory (data repository 108).

Further, the information retrieval module 216 is configured to load the one or more blocks corresponding to the one or more target views, from the dwarf data structure, into a primary memory (Random Access Memory). In one embodiment, the one or more blocks corresponding to the one or more target views may be identified using the lookup file.

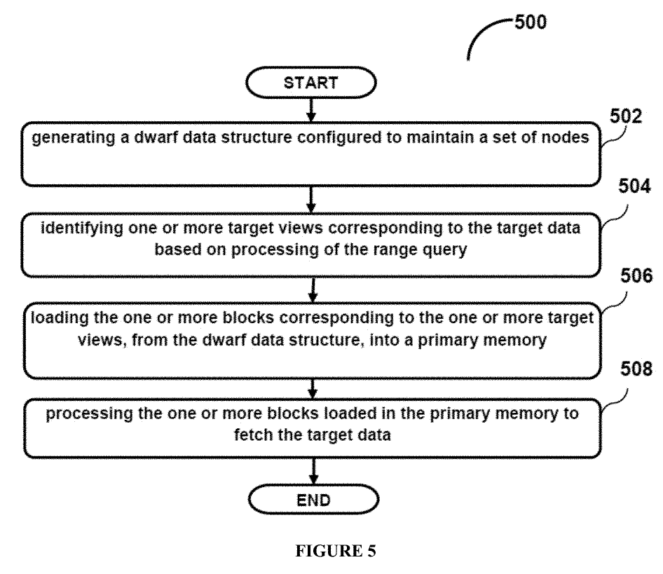

Further, the information retrieval module 216 may process the one or more blocks loaded in the primary memory to fetch the target data. Once the target data is retrieved, in the next step, the information retrieval module 216 is configured to transmit the target data to the user device. Further, the method for generating the dwarf data structure and fetching information from the dwarf data structure is further elaborated with respect to the block diagram of FIG. 5.

Referring now to FIG. 5, a method 500 for generating the dwarf data structure and fetching information from the dwarf data structure, is disclosed in accordance with an embodiment of the present subject matter. The method 500 may be described in the general context of computer executable instructions. Generally, computer executable instructions can include routines, programs, objects, components, data structures, procedures, modules, functions, and the like, that perform particular functions or implement particular abstract data types. The method 500 may also be practiced in a distributed computing environment where functions are performed by remote processing devices that are linked through a communications network. In a distributed computing environment, computer executable instructions may be located in both local and remote computer storage media, including memory storage devices.

The order in which the method 500 is described is not intended to be construed as a limitation, and any number of the described method blocks can be combined in any order to implement the method 500 or alternate methods. Additionally, individual blocks may be deleted from the method 500 without departing from the spirit and scope of the subject matter described herein. Furthermore, the method 500 can be implemented in any suitable hardware, software, firmware, or combination thereof. However, for ease of explanation, in the embodiments described below, the method 500 may be considered to be implemented in the above described system 102.

At block 502, the dwarf building module 212 may generate a dwarf data structure configured to maintain a set of nodes. In one embodiment, for the purpose of building the dwarf data structure, the dwarf building module 212 may first receive processed analytical data from external data sources 112. Further, the dwarf building module 212 may be configured to generate a fact table based on the processed analytical data. Furthermore, the dwarf building module 212 may generate a set of nodes corresponding to the dwarf data structure. In one embodiment, each node from the set of nodes is configured to maintain information of a data point corresponding to one or more dimensions from a set of dimensions associated with the fact table. In one embodiment, one or more techniques available in the art may be used for generating the set of nodes.

Once the set of nodes is generated, the dwarf building module 212 may determine a first set of views corresponding to the set of dimensions. The first set of views comprises all the views that may be generated using the possible combination of dimensions from the set of dimensions. In one embodiment, each view from the first set of views is associated with a subset of nodes from the set of nodes. Further, the dwarf building module 212 may identify a second set of views from the first set of views based on a set of predefined parameters. The set of predefined parameters may include available memory space in the data repository 108, views that may give maximum leverage during querying, and the like.

Further, the dwarf building module 212 may generate one or more data block corresponding to each view from the second set of views. The one or more data blocks corresponding to each view are configured to store a subset of nodes corresponding to the view from the second set of views. In one embodiment, a node from the first set of nodes may be common to two or more views, from the second set of views. In such a situation, the dwarf building module 212 a view, from the two or more views, having least number of dimensions associated therewith is identified. One the view with least number of dimensions is identified, the dwarf building module 212 is configured to store the node in a block corresponding to the view with least number of dimensions.

The size of the data block may be determined based on the number of dimensions associated with the dwarf data structure and the density of the dwarf data structure. Further, the dwarf building module 212 may store the one or more blocks corresponding to each view from the second set of views in a secondary memory/data repository 108. It is to be noted that all the data blocks corresponding to a particular view from the second set of views are stored in the form of linked list. By storing the data blocks in the form of linked list, the system 102 may easily retrieve the data blocks that belong to the same view using the pointers in the linked list, wherein a pointer, corresponding to a block, points to the memory location of the succeeding block. The dwarf building module 212 may generate one or more global blocks. The one or more global blocks may be configured to store all the nodes, from the first set of nodes, corresponding to one or more global views. The one or more global blocks enables maintaining all the nodes that are less frequently used. Further, the dwarf building module 212 may pre-process the one or more blocks corresponding to the second set of views and the one or more global blocks before loading the one or more blocks corresponding to the second set of views and the one or more global blocks in the secondary memory. The preprocessing may correspond to physical compression of the blocks to be stored in the secondary memory (Disk space).

Further, the dwarf building module 212 may maintain a block-relative position, corresponding to each node stored in the secondary memory, in a lookup file. The block-relative position may be a combination of a block number corresponding to the block and an offset value indicating position of the node in the block. The combination of block number and offset value for each node may be used to identify the physical location of each node in data repository 108.

At block 504, once the dwarf data structure is generated and stored in the data repository 108, the query processing module 214 is configured to receiving a range query for retrieving target data from the dwarf data structure. The range query may be received from a user device 104 linked with the system 102.

Further, query processing module 214 is configured to identify one or more target views corresponding to the target data based on processing of the range query. For example, the range query may correspond to target data stored in a data blocks associated with a particular view from the second set of views. This view is referred to as the target view, and data blocks corresponding to the target view are identified from the secondary memory (data repository 108).

At block 506, the information retrieval module 216 is configured to load the one or more blocks corresponding to the one or more target views, from the dwarf data structure, into a primary memory (Random Access Memory). In one embodiment, the one or more blocks corresponding to the one or more target views may be identified using the lookup file.

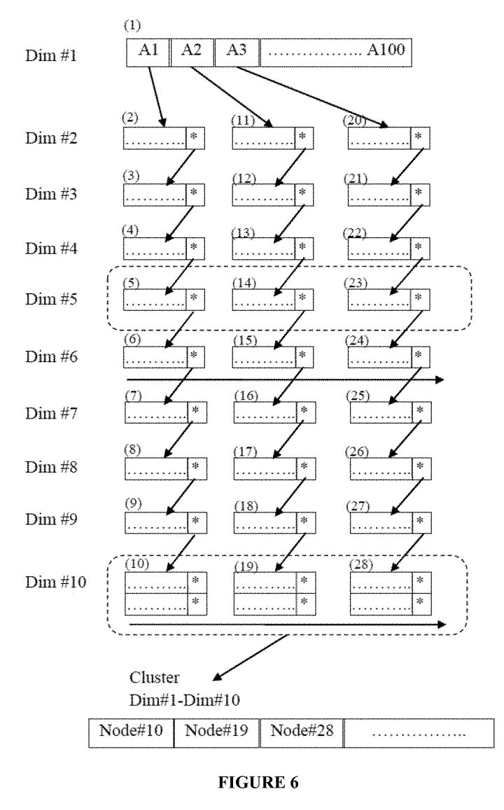

At block 508, the information retrieval module 216 may process the one or more blocks loaded in the primary memory to fetch the target data. Once the target data is retrieved, in the next step, the information retrieval module 216 is configured to transmit the target data to the user device. Further, the arrangement of nodes, corresponding to the dwarf data structure, in the secondary memory is further elaborated with respect to FIG. 6.

Referring now to FIG. 6, the arrangement of nodes, corresponding to the dwarf data storage, in the data repository 108 is illustrated, in accordance with an embodiment of the invention. As represented in FIG. 6, the nodes corresponding to the same view are stored in the form of a linked list. This means that the system can always skip the intermediate nodes between the root dimension and the next queried dimension (in order of the dimensions in the Dwarf data structure). This is possible as the system has clustered together, the nodes of the view formed by the first two queried dimensions in the query (Like view ‘AD’ was clustered in the query for view ADE). So they will be stored sequentially in the order of root cells. This means the 1^{st} node of the ‘second queried dimension’ pointed by the 1^{st} root cell (via path containing the intermediate nodes * cells) is written first in the cluster, followed by the 2^{nd} node of the ‘second queried dimension’ pointed by 2^{nd} root cell, 3^{rd} node of the ‘second queried dimension’ pointed by the 3^{rd} root cell and so on.

Due to this arrangement of nodes, while querying, the system 102 considers the view formed by the first two queried dimensions, and from which position the nodes of the view are written in the Dwarf data structure file. While building the cubes the system 102 is configured to store the starting position of each view. At the time of querying the system 102 can start reading from the view formed by the first two queried dimensions in the query. While reading the nodes the system 102 is aware that the ‘second queried dimension's nodes are in the order of root cells which helps the system 102 in determining the value of the root dimension associated with the nodes of the second queried dimension. As a result, the number of nodes and also the blocks that needs to be read to serve queries involving all the cells of the root node is reduced. Thus, the I/O operations are reduced and hence the query performance is improved drastically.

In one example, if a query for getting all the combinations of the view (D1, D4, and D5) in a cube of 5 dimensions (Dim#1, Dim#2, Dim#3, Dim#4, Dim#5 assuming dimensions are in same order in Dwarf data structure) is fired at the system 102, then the system 102 is configured to serve this query by reading the root node and then start reading the Dwarf data structure directly from dimension Dim#4.

The traditional way of serving this query (in absence of clustering) performed is by starting from root dimension Dim#1 and then going through the intermediate * cells for the nodes of Dim#2 and Dim#3 and then to Dim#4 as represented in FIG. 2. However, due to clustering and the view-reading approach of the system 102 enables saving the reading of nodes Dim#2 and Dim#3.

In one example, considering a sample range query where all members for Dim#1 need to be read (such as finding top#N members for Dim#1, which is one common query in many kind of analytics). To serve this query usually a conventional cube processing system is configured to start reading from the root node, which is node for Dim#1 and then for each cell of it, the system 102 is configured to read next dimension node follow its star cell to read next dimension node and keep following the star (*) cells to read next dimension node until the leaf node is reached. Thus for each cell of Dim#1, nine node reads are required to reach to the leaf node, by a conventional cube processing tool as disclosed in FIG. 2. Each root-to-leaf reading requires nodes from different dimensions which are stored far apart from each other on the disk thus forcing disk head to move back and forth abruptly leading to poor I/O throughput.

However, in the present system, given that the system 102 has already clustered all the nodes for view (Dim#1-Dim#10), when the system 102 is iterating Dim#1 cells, all the leaf nodes following all the star (*) paths (i.e. Dim#10 nodes pointed by <Dim#1, *, *, *, *, *, *, *, *, Dim#10> path) are stored next to each other, the system 102 can read them sequentially, without having to read the intermediate dimension nodes as disclosed in FIG. 6.

For this purpose, the system 102 just need to refer the starting position of this View of two dimensions (Dim#1-Dim#10). While building the Dwarf data structures, the system 102 is configured to maintain the starting position of this view and then at the time of querying the system 102 may use it to read the Dim#10 nodes (pointed by <Dim#1, *, *, *, *, *, *, *, *, Dim#10> path) directly.

In one example, consider the Dwarf data structure shown below in FIG. 1 and the processing performed by the system 102 to process the queries is as below:

### 1) Query#1 (?, C2, *)

This query can be served by reading nodes of cluster (D1, D2) and result is:

### S1, C2, * $70

### 2) Query#2 (?, *, *)

This query can be served by reading nodes of cluster (D1, D3) and result is:

### S1, *, * $110

### S2, *, * $140

### 3) Query#3 (?, *, ?)

This query can be served by reading nodes of cluster (D1, D3) and result is:

### S1, *, P1 $40

### S1, *, P1 $70

### S2, *, P1 $90

### S2, *, P2 $50

This the number of read cycles can be reduced to improve IO throughput and improve OLAP query performance from Dwarf data structure.

Although implementations of system and method for building the dwarf data structure with reduced size and fetching data from the dwarf data structure have been described in language specific to structural features and/or methods, it is to be understood that the appended claims are not necessarily limited to the specific features or methods described. Rather, the specific features and methods are disclosed as examples of implementations for size of Dwarf data structure and improving query performance.

We claim:

1. A method for fetching data from a dwarf data structure, the method comprising:
generating a dwarf data structure configured to maintain a set of nodes, wherein the dwarf data structure is built by:
generating the set of nodes corresponding to the dwarf data structure, wherein each node is configured to maintain information of a data point corresponding to one or more dimensions from a set of dimensions associated with a fact table;
determining a first set of views corresponding to the set of dimensions, wherein each view from the first set of views is associated with a subset of nodes from the set of nodes;
identifying a second set of views from the first set of views, wherein the second set of views are determined based on a set of predefined parameters;
generating one or more data block corresponding to each view from the second set of views, wherein the one or more data blocks corresponding to each view are configured to store the subset of nodes corresponding to the view from the second set of views;
storing the one or more blocks corresponding to each view from the second set of views in a secondary memory, wherein the one or more blocks corresponding to each view from the second set of views are stored in the form of a linked list;
maintaining a block-relative position, corresponding to each node stored in the secondary memory, in a lookup file, thereby building the dwarf data structure in the secondary memory;
receiving a range query for retrieving target data from the dwarf data structure;
identifying one or more target views corresponding to the target data based on processing of the range query;
loading the one or more blocks corresponding to the one or more target views, from the dwarf data structure, into a primary memory, wherein the one or more blocks are identified using the lookup file; and
processing the one or more blocks loaded in the primary memory to fetch the target data.

2. The method of claim 1 further comprising,
generating a one or more global blocks, wherein the one or more global blocks are configured to store all the nodes, from the first set of nodes, corresponding to one or more global views, and
pre-processing the one or more blocks corresponding to the second set of views and the one or more global blocks before loading the one or more blocks corresponding to the second set of views and the one or more global blocks in the secondary memory.

3. The method of claim 1, wherein the fact table is configured to maintain processed analytical data received from external data sources.

4. The method of claim 1, wherein the size of the data block is determined based on the number of dimensions associated with the dwarf data structure and the density of the dwarf data structure.

5. The method of claim 1, wherein a node common to two or more views, from the second set of views, is stored at a block from the one or more blocks corresponding to a view, from the two or more views, corresponding to least number of dimensions.

6. The method of claim 1, wherein the block-relative position is a combination of a block number corresponding to the block and an offset value indicating position of the node in the block.

7. The method of claim 1, wherein the set of predefined parameters comprise available memory space in the secondary memory and leverage for query processing.

8. A system for fetching data from a dwarf data structure, the system comprising:
a memory; and
a processor coupled to the memory, wherein the processor is configured to process programmed instructions stored in the memory for:
generating a dwarf data structure configured to maintain a set of nodes, wherein the dwarf data structure is built by:
generating the set of nodes corresponding to the dwarf data structure, wherein each node is configured to maintain information of a data point corresponding to one or more dimensions from a set of dimensions associated with a fact table;
determining a first set of views corresponding to the set of dimensions, wherein each view from the first set of views is associated with a subset of nodes from the set of nodes;
identifying a second set of views from the first set of views, wherein the second set of views are determined based on a set of predefined parameters;
generating one or more data block corresponding to each view from the second set of views, wherein the one or more data blocks corresponding to each view are configured to store the subset of nodes corresponding to the view from the second set of views;
storing the one or more blocks corresponding to each view from the second set of views in a secondary memory, wherein the one or more blocks corresponding to each view from the second set of views are stored in the form of a linked list;
maintaining a block-relative position, corresponding to each node stored in the secondary memory, in a lookup file, thereby building the dwarf data structure in the secondary memory;
receiving a range query for retrieving target data from the dwarf data structure;
identifying one or more target views corresponding to the target data based on processing of the range query;
loading the one or more blocks corresponding to the one or more target views, from the dwarf data structure, into a primary memory, wherein the one or more blocks are identified using the lookup file; and
processing the one or more blocks loaded in the primary memory to fetch the target data.

9. The system of claim 8 further configured for,
generating a one or more global blocks, wherein the one or more global blocks are configured to store all the nodes, from the first set of nodes, corresponding to one or more global views, and
pre-processing the one or more blocks corresponding to the second set of views and the one or more global blocks before loading the one or more blocks corresponding to the second set of views and the one or more global blocks in the secondary memory.

10. The system of claim 8, wherein the fact table is configured to maintain processed analytical data received from external data sources.

11. The system of claim 8, wherein the size of the data block is determined based on the number of dimensions associated with the dwarf data structure and the density of the dwarf data structure.

12. The system of claim 8, wherein a node common to two or more views, from the second set of views, is stored at a block from the one or more blocks corresponding to a view, from the two or more views, corresponding to least number of dimensions.

13. The system of claim 8, wherein the block-relative position is a combination of a block number corresponding to the block and an offset value indicating position of the node in the block.

14. The system of claim 8, wherein the set of predefined parameters comprise available memory space in the secondary memory and leverage for query processing.

15. A non-transitory computer readable medium embodying a program executable in a computing device for fetching data from a dwarf data structure, the program comprising:
a program code for generating a dwarf data structure configured to maintain a set of nodes, wherein the dwarf data structure is built by:
generating the set of nodes corresponding to the dwarf data structure, wherein each node is configured to maintain information of a data point corresponding to one or more dimensions from a set of dimensions associated with a fact table;
determining a first set of views corresponding to the set of dimensions, wherein each view from the first set of views is associated with a subset of nodes from the set of nodes;
identifying a second set of views from the first set of views, wherein the second set of views are determined based on a set of predefined parameters;
generating one or more data block corresponding to each view from the second set of views, wherein the one or more data blocks corresponding to each view are configured to store the subset of nodes corresponding to the view from the second set of views;
storing the one or more blocks corresponding to each view from the second set of views in a secondary memory, wherein the one or more blocks corresponding to each view from the second set of views are stored in the form of a linked list;
maintaining a block-relative position, corresponding to each node stored in the secondary memory, in a lookup file, thereby building the dwarf data structure in the secondary memory;
a program code for receiving a range query for retrieving target data from the dwarf data structure;
a program code for identifying one or more target views corresponding to the target data based on processing of the range query;
a program code for loading the one or more blocks corresponding to the one or more target views, from the dwarf data structure, into a primary memory, wherein the one or more blocks are identified using the lookup file; and
a program code for processing the one or more blocks loaded in the primary memory to fetch the target data.
